(19) United States
(12) Patent Application Publication
(10) Pub. No.: US 2009/0079218 A1
(43) Pub. Date: Mar. 26, 2009

(54) DEVICE FOR DETECTING A SEAT OCCUPANCY STATUS

(75) Inventors: Manfred Frimberger, Ergoldsbach (DE); Henderikus-L. Offerein, Langquaid (DE); Gerald Schicker, Maxhutte-Haidhof (DE); Gerd Winkler, Regensburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/239,044

(22) Filed: Sep. 26, 2008

(30) Foreign Application Priority Data
Sep. 26, 2007 (DE) 10 2007 045 983.3

(51) Int. Cl. B60N 2/075; G01G 19/08

(52) U.S. Cl. 296/65.14; 296/65.13; 177/245

(57) ABSTRACT

A device for detecting the seat occupancy status in a motor vehicle is configured in a seat that is supported to allow movement in a direction on front and rear supports on a seat rail attached to the floor of the motor vehicle. The seat, at the lower end of its backrest, has seat belt anchorage points above the rear supports for mechanical anchorage of a seat belt. Weight sensors assigned to the rear supports are arranged in the force path below the seat belt anchorage points and above the seat rail.

### CROSS-REFERENCE TO RELATED APPLICATIONS

This application claims the priority, under 35 U.S.C. § 119, of German application DE 10 2007 045 983.3, filed Sep. 26, 2007; the prior application is herewith incorporated by reference in its entirely.

### BACKGROUND OF THE INVENTION

1. Field of the Invention

The invention lies in the automotive technology field.

In motor vehicles a seat occupancy detection system is required for optimum synchronization and control of safety devices such as seat belt tensioners or airbags.

Prior art systems for weight sensing to determine the seat occupancy status normally use four sensors to evaluate the weight information. Generic systems are described, for example, in U.S. Pat. No. 6,563,429 B2 (cf. JP 2000-290700, DE 601 27 358 T2).

Considerable effort is required to evaluate these four sensors. Also, the industry is under constant pressure to reduce costs.

### SUMMARY OF THE INVENTION

It is accordingly an object of the invention to provide a system for detecting a seat occupancy status, which overcomes the above-mentioned disadvantages of the heretofore-known devices and methods of this general type and which reduces the existing system consisting of four sensors and especially cuts costs.

With the foregoing and other objects in view there is provided, in accordance with the invention, a device for detecting a seat occupancy status in a motor vehicle, the device comprising:

a seat rail attached to a floor of the motor vehicle, front and rear supports, and a seat movably supported to allow movement in a given direction on said front and rear supports;

said seat having a backrest and seat belt anchorage points for mechanical anchorage of a seat belt disposed at a lower end of said backrest above said rear supports; and

a plurality of weight sensors assigned exclusively to said rear supports and disposed in a weight path below said seat belt anchorage points and above said seat rail.

In other words, a novel device for detecting the seat occupancy status in a motor vehicle is provided. The seat is supported on front and rear supports on a seat rail attached to the floor of the motor vehicle. The supports are movably disposed to allow movement in a given direction. At the lower end of its backrest, the seat has safety belt anchorage points above the rear supports. The anchorage points enable mechanical anchorage of a safety belt. Weight sensors are exclusively assigned to the rear supports and disposed in the force path below the seat belt anchorage points and above the seat rail.

In accordance with an added feature of the invention, the weight sensors are integrated into the rear supports that are guided to allow movement on the seat rail directly above the seat rail.

In accordance with an additional feature of the invention, the supports are advantageously attached to an additional top bar which slides on the seat rail.

In accordance with a concomitant feature of the invention, there are provided articulated joints or spring elements which absorb torsion or stresses. These devices are disposed between the front and/or the rear supports and the seat.

Other features which are considered as characteristic for the invention are set forth in the appended claims.

Although the invention is illustrated and described herein as embodied in a device for determining seat occupancy, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a schematic diagram of the structure of a device according to the invention for the detection of the seat occupancy status in a motor vehicle, viewed from the side;

FIG. 2 shows the schematic diagram from FIG. 1, with weight force being introduced into the seat by a person,

FIG. 3 shows a schematic diagram of a front view of the structure of an inventive device for detection of the seat occupancy status in a motor vehicle,

FIG. 4 shows a schematic detailed view of an articulated joint between seat and seat rail, and

FIG. 5 shows a schematic detailed view of a spring element between seat and seat rail.

### DETAILED DESCRIPTION OF THE INVENTION

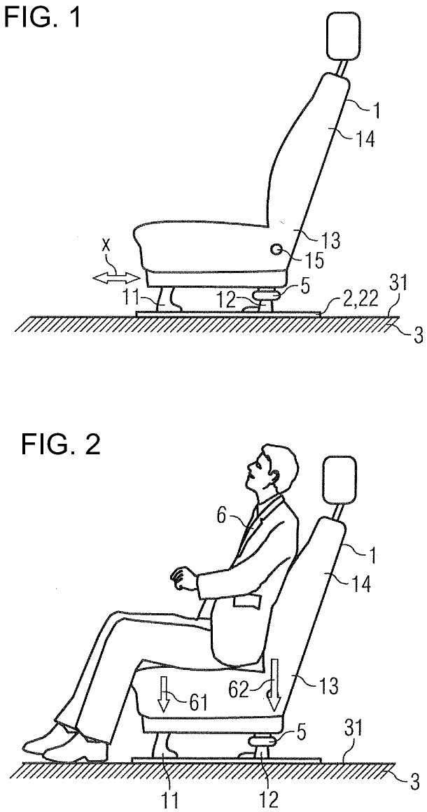

Referring now to the figures of the drawing in detail and first, particularly, to FIG. 1 thereof, there is shown a schematic diagram of the structure of a device for the detection of the seat occupancy status in a motor vehicle 3, viewed from the side. The seat 1 is supported on its front and rear supports 11, 12 on a seat rail 2; 21, 22 attached to the floor 31 of the motor vehicle 3 so that it is able to move in a direction x.

Arranged at the lower end 13 of the backrest 14 of the seat 1 and still above the rear supports 12 (level B in FIG. 3) are seat belt anchorage points 15 for mechanically anchoring a seat belt 4 (level A in FIG. 3).

Weight sensors 5 are provided below these seat belt anchorage points 15. The sensors 5 are assigned to the rear supports 12, which are arranged in the force path below the seat belt anchorage points 15 and above the seat rail 2; 21, 22.

In the illustrated example the weight sensors 5 are integrated directly above the seat rail 2; 21, 22 into the rear supports 12 guided to allow them to move on the seat rail 2; 21, 22.

FIG. 2 shows a schematic diagram of a seat occupied by a person 6, who exerts a weight force via force paths 61 and 62. The main force path in this case lies over the rear supports 12 and passes through the weight sensors 5.

FIG. 3 shows a schematic diagram of the structure of the device in a motor vehicle 3 from FIGS. 1 and 2, viewed from the front.

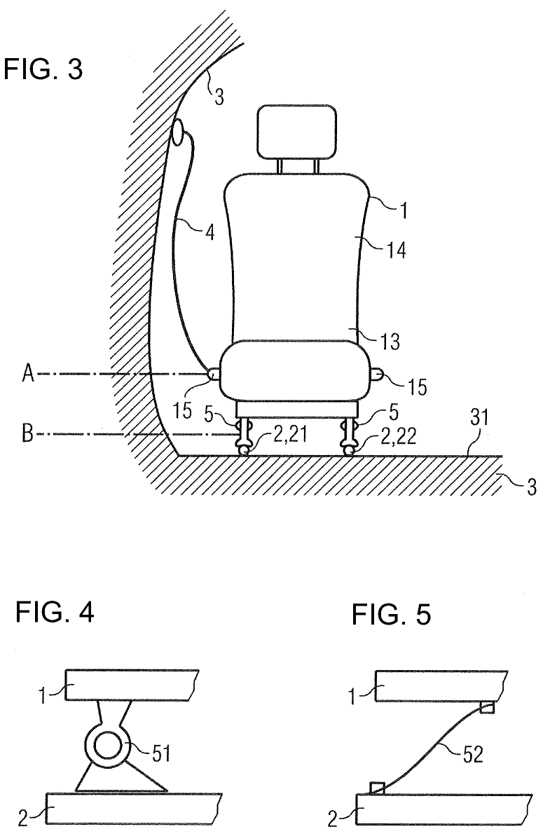

FIG. 4 and FIG. 5 show a detailed view of articulated joints 51 arranged between the front supports 11 and the seat 1 which absorb torsion or stresses in the seat or between the seat 1 and the seat rail 2.

FIG. 5 shows a variant in which a spring element 52 replaces an articulated joint in the arrangement.

These articulated joints or spring elements enable pre-stresses of the screw connections between the seat superstructure and the seat rail, which may become loose over the useful lifetime of the seat frame, to be reduced.

1. A device for detecting a seat occupancy status in a motor vehicle, the device comprising:
a seat rail attached to a floor of the motor vehicle, front and rear supports, and a seat movably supported to allow movement in a given direction on said front and rear supports;
said seat having a backrest and seat belt anchorage points for mechanical anchorage of a seat belt disposed at a lower end of said backrest above said rear supports; and
a plurality of weight sensors assigned exclusively to said rear supports and disposed in a weight path below said seat belt anchorage points and above said seat rail.

2. The device according to claim 1, wherein said rear supports are guided to allow movement on said seat rail and said weight sensors are integrated in said rear supports directly above said seat rail.

3. The device according to claim 1, which comprises an additional top bar disposed to slide on said seat rail, and wherein said supports are attached to said additional top bar.

4. The device according to claim 1, which comprises one or more torsion or stress reducing devices disposed between said front supports and/or said rear supports.

5. The device according to claim 4, wherein said torsion or stress reducing devices are joints or spring elements configured to absorb torsion or stress.
